(19) United States
(12) Patent Application Publication
(10) Pub. No.: US 2017/0209793 A1
(43) Pub. Date: Jul. 27, 2017

(54) System and Method for Live Interactive Coaching Game

(71) Applicant: Reggie Johnson, Vallejo, CA (US)

(72) Inventor: Reggie Johnson, Vallejo, CA (US)

(21) Appl. No.: 15/197,393

(22) Filed: Jun. 29, 2016

Related U.S. Application Data
(60) Provisional application No. 62/386,023, filed on Nov. 16, 2015.

(51) Int. Cl. A63F 13/5375; A63F 13/87; A63F 13/86

(52) U.S. Cl. CPC A63F 13/5375; A63F 13/86; A63F 13/87

(57) ABSTRACT

This invention relates to a system and method for allowing spectators to instruct sporting event participants on how to act within the sporting event. This is similar to the traditional role of a coach during sporting events, but the coach would be replaced by interactivity from the spectators.

Spectators select certain actions they would like the participants to perform by inputting selections into client electronic devices. The client devices transmit information about the selections to an aggregator. The aggregator receives information from various client devices and updates a coaching display to show the most popular selection. The sporting event participants get information on what actions to perform next from the coaching display.

### BACKGROUND

Viewing traditional sporting events as a spectator is a popular activity. Recently, it has also become a popular activity to view video gaming or “e-sports” events as a spectator. While “e-sports” events allow more opportunity for interactivity, spectators still typically act passively without influencing the outcome of the event. It would be useful to have new and innovative ways to entice spectators by allowing some interactivity with the event they are viewing.

### SUMMARY

This invention relates to a system and method for allowing spectators to instruct sporting event participants on how to act within the event. This is similar to the traditional role of a coach during sporting events, but the coach would be replaced by interactivity from the spectators. This system and method entices more spectators by creating a higher level of involvement than the traditional spectator role allows.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is an overview of the flow of an embodiment of the system or method.

FIG. 2 is an overview of the flow of the user client portion of an embodiment of the system or method.

### DETAILED DESCRIPTION

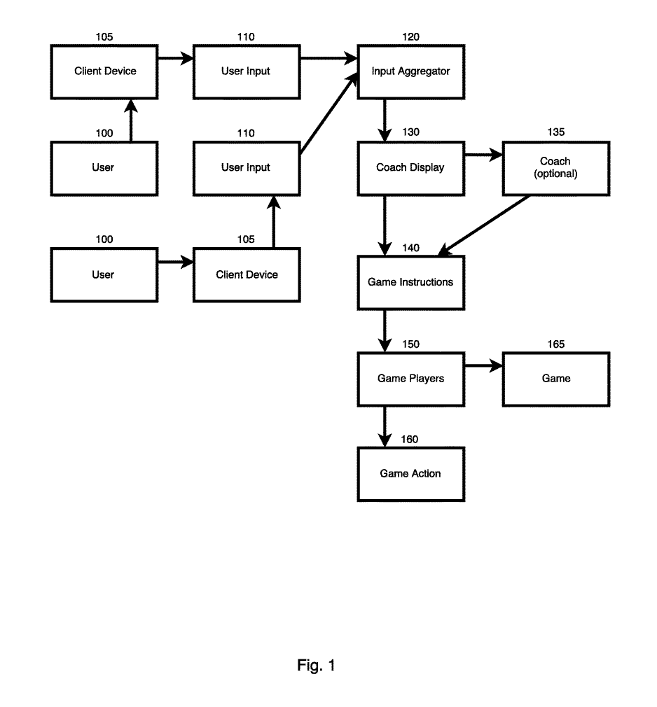

In the particular embodiment illustrated in FIG. 1, users 100 are persons interested in viewing and interacting with game 165. Users interact by operating client devices 105 to send user input 110 to input aggregator 120.

Client devices 105 are electronic devices that are capable of running software, receiving input, and transmitting information electronically. Client devices 105 can be cellular telephones, tablet computers, or other electronic devices. The operation of client devices 105 as it related to this particular embodiment is described further below.

User input 110 is composed of selections made by users 100 operating client devices 105. User input 110 is transmitted to input aggregator 120.

Input aggregator 120 can be a tablet computer, cellular telephone, or other electronic device capable of receiving electronic transmissions and displaying information. Input aggregator 120 receives user input 110 from a variety of sources and updates coach display 130.

Coach display 130 can be a tablet computer, cellular telephone, or other electronic device capable of receiving electronic transmissions and displaying information, and can further be the same physical device as input aggregator 120. Coach display 130 displays game instructions 140.

Coach 135 is a person who reads coach display 130. Coach 135 is optional.

Game instructions 140 are information about game decisions that a majority of the users 200 wish for game players 150 to carry out as game action 160. Game instructions 140 might be instructions such as substituting one game player 150 for another, or instructions for game players 150 to run a particular play or switch to a particular strategy.

Game players 150 are participants in game 165. Game 165 is a game involving physical activity, such as basketball. Game players 150 receive game instructions 140 from coach display 130 or optionally from coach 135. Game players 150 attempt to carry out game instructions 140 by implementing game action 160.

Game action 160 is a particular action relating to the play of game 165, such as substituting a player, calling a timeout, running a particular play, or executing a particular strategy.

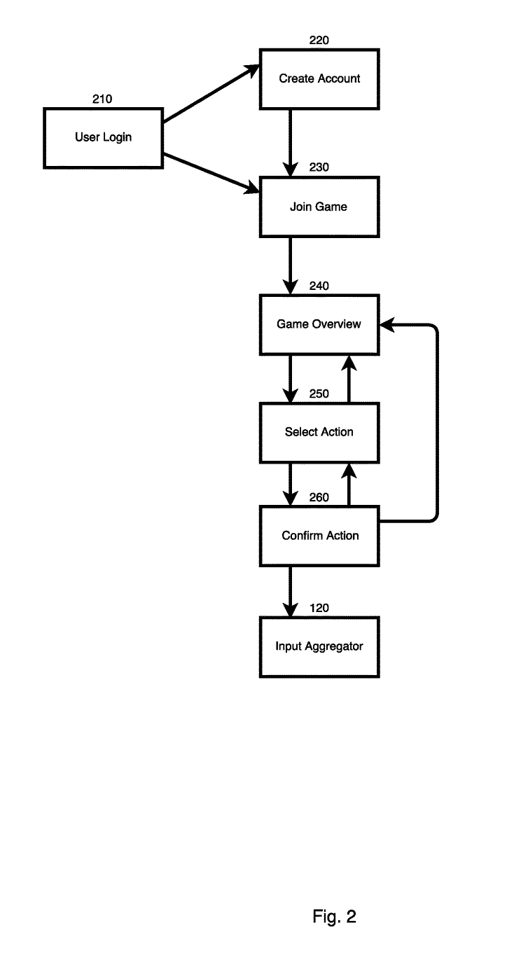

In the particular embodiment illustrated in FIG. 2, a user 100 operating a client device 105 is first presented with user login screen 210. User login screen 210 allows the user 100 to log in using typical methods that are well-known in the art. If the user 100 chooses to create a new account, he is next presented with create account screen 220.

Create account screen 220 allows a user 100 to enter credentials and create an account using typical methods that are well-known in the art.

Once the user 100 has successfully logged in or created a new account, the user 100 is presented with join game screen 230. Join game screen 230 presents a list of active or upcoming games 165 and allows the user 100 to select which game 165 he would like to join. Once the user 100 selects a game 165 to join he is presented with game overview screen 240.

Game Overview screen 240 presents information about the current game 165, such as the score and time remaining, and allows the user 100 to input an action. If the user 100 chooses to input an action, he will be presented with select action screen 250.

Select action screen 250 presents a list of available game instructions 140, such as calling for a player substitute or selecting a particular play or strategy. The user 100 can select an action or return to the game overview screen 240. If the user 100 selects an action, he is presented with confirm action screen 260.

Confirm action screen 260 presents the user 100 with any additional information regarding the selected action, and allows the user 100 to choose whether he will confirm the selected action. If the user 100 confirms the selected action, client device 105 transmits information about the selected action as user input 110 to input aggregator 120, and the user 100 is returned to game overview screen 240. If the user 100 does not confirm the selected action, he is returned to select action screen 250.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

What is claimed is:

1. An electronic live interactive coaching system comprising:
a processor;
a client unit;
a server unit;
a computer readable storage media that comprises instructions stored in the computer readable storage media that are executable with the processor, the instructions comprising:
instructions for the client to display a list of available coaching actions;
instructions to transmit information about the selected action from the client to the server in response to an action selection command indicative of a user selecting an action from the list of coaching actions;
instructions for the server to compute and display the most popular coaching action selected by clients in response to receiving a threshold number of transmissions from clients;
instructions for the server to compute and display the most popular coaching action selected by clients in response to a threshold amount of time elapsing since the last such computation.

2. A method of electronic live interactive coaching comprising:
displaying with a display device a list of available coaching actions;
in response to receipt from a selection device of an action selection command:
retrieving from a database and displaying with the display device information about the selected item's price and quantity available;
in response to receipt from the selection device of an action selection command:
transmitting to a computing device information about the action selection command
displaying with a second display device a winning coaching action;
in response to receipt of a transmission of information about an action selection command:
computing a winning coaching action.
